(19) United States
(12) Patent Application Publication
(10) Pub. No.: US 2024/0210592 A1
(43) Pub. Date: Jun. 27, 2024

(54) CONTINENTAL SHELF PROFILE DETERMINING METHOD AND APPARATUS BASED ON NON-DELTA TRANSGRESSION

(71) Applicant: China University of Petroleum-Beijing, Beijing (CN)

(72) Inventors: Junhui Wang, Beijing (CN); Tetsuji Muto, Beijing (CN); Benzhong Xian, Beijing (CN); Liming Gao, Beijing (CN)

(21) Appl. No.: 18/288,541

(22) PCT Filed: Apr. 27, 2022
(86) PCT No.: PCT/CN2022/089455

§ 371 Date: Oct. 26, 2023

(30) Foreign Application Priority Data
Apr. 27, 2021 (CN) 202110458579.6

(51) Int. Cl. G01V 20/00

(52) U.S. Cl. CPC G01V 20/00

(57) ABSTRACT

The present disclosure provides a continental shelf profile determining method and apparatus based on non-delta transgression. The method includes: constructing a continental shelf profile two-dimensional model based on a river supply sediment volume and a sea level rise rate in a target work area; solving the two-dimensional model in a spatial rectangular coordinate system to generate a relational expression which is capable of representing a non-delta transgression slope and a river length; and determining a continental shelf profile of the target work area based on the relational expression. In the context of non-delta transgression, the continental shelf profile determining method and apparatus based on non-delta transgression provided by the present disclosure comprehensively consider the influences of a river sediment supply and a sea level rise on the continental shelf profile, to more accurately determine the change of the continental shelf profile of the target work area in the historical period.

### TECHNICAL FIELD

The present disclosure relates to a technical field of oil and gas exploration and a field of marine geologies, especially to the technical field of stratigraphic superposition pattern analysis, and particularly to a continental shelf profile determining method and apparatus based on non-delta transgression.

### BACKGROUND

In the prior art, the calculation of the continental shelf profile is based on the erosion of waves on the seabed. Specifically, the basic principle is that the water depth of the continental shelf gradually becomes shallower from a deep-sea direction to a continental direction; as the water depth becomes shallower, the effect of waves on the seabed sediments is strengthened, and the sediments are more severely damaged. Sediments damaged in shallow water will be transported to relatively deep water and be deposited there. This process will eventually reach an equilibrium state, in which case the continental shelf profile is also called an equilibrium profile. Therefore, the equilibrium profile of the continental shelf should be characterized by a steepening landwards, which is extended to the context of the sea level rise called Bruun's rule (Bruun, 1962). The basic principle is that due to the sea level rise, the original land part is submerged and becomes a shallow-water area, so that the early land sediments are eroded and transported to a deep-water area to form a new equilibrium profile. Therefore, in the context of the sea level rise, the new formed continental shelf is still characterized by steepening landwards (FIG. 1). The above method for calculating the continental shelf profile has the following disadvantages:
(1) The prior art is applicable to small time scales such as tens to hundreds of years, belonging to the field of engineering, and it is assumed that external conditions such as geological structure and sediment supply will not change. In the time scales of thousands to hundreds of thousands of years, the external conditions also change slowly, and the above technology is difficult to be applied.
(2) The effects of the sediment supply in the land direction is not considered in the prior art. The continental shelf is usually caused by the sea level rise. The sea level rise causes the land to be submerged, thereby forming the continental shelf. In the vicinity of the coastline, in addition to the fact that the sea level rise tends to make the coastline move landwards, the fluvial action often tends to make the coastline move seawards at the same time, and the existing solution does not consider the latter.

### SUMMARY

Regarding the problems in the prior art, in the context of non-delta transgression, a method and apparatus for determining a continental shelf profile based on non-delta transgression provided by the present disclosure comprehensively consider the influences of a river sediment supply and a sea level rise on a continental shelf profile to more accurately determine the change of the continental shelf profile of a target work area in the historical period.

In a first aspect, the present disclosure provides a method for determining a continental shelf profile based on non-delta transgression, including:

constructing a continental shelf profile two-dimensional model based on a river supply sediment volume and a sea level rise rate in a target work area;

solving the continental shelf profile two-dimensional model in a spatial rectangular coordinate system to generate a relational expression which is capable of representing a non-delta transgression slope and a river length; and

determining a continental shelf profile of the target work area based on the relational expression.

In an embodiment, constructing a continental shelf profile two-dimensional model based on a river supply sediment volume and a sea level rise rate in a target work area includes:

calculating a longitudinal increment of an alluvial range of the target work area per unit time;

calculating a sediment volume per unit time based on the longitudinal increment and a sediment volume supply rate; and

calculating the river supply sediment volume based on the sediment volume per unit time.

In an embodiment, in the continental shelf profile two-dimensional model,

an inland basement slope, an alluvial slope, a sediment supply rate of an upstream of the river and the sea level rise rate are all constant; and

the river has an initial length at the beginning of a sea level rise.

In an embodiment, solving the continental shelf profile two-dimensional model in a spatial rectangular coordinate system to generate a relational expression which is capable of representing a non-delta transgression slope and a river length comprises:

solving the continental shelf profile two-dimensional model in an x-z coordinate system to generate the relational expression.

In a second aspect, the present disclosure provides an apparatus for determining a continental shelf profile based on non-delta transgression, comprising:

a model construction unit configured to construct a continental shelf profile two-dimensional model based on a river supply sediment volume and a sea level rise rate in a target work area;

a model solution unit configured to solve the continental shelf profile two-dimensional model in a spatial rectangular coordinate system to generate a relational expression which is capable of representing a non-delta transgression slope and a river length; and

a profile determination unit configured to determine a continental shelf profile of the target work area based on the relational expression.

In an embodiment, the model construction unit comprises:

a longitudinal increment calculation module configured to calculate a longitudinal increment of an alluvial range of the target work area per unit time;

a sediment volume calculation module configured to calculate a sediment volume per unit time based on the longitudinal increment and a sediment volume supply rate; and

a river supply volume calculation module configured to calculate the river supply sediment volume based on the sediment volume per unit time.

In an embodiment, in the continental shelf profile two-dimensional model,

an inland basement slope, an alluvial slope, a sediment supply rate of an upstream of the river and the sea level rise rate are all constant; and

the river has an initial length at the beginning of a sea level rise.

In an embodiment, the model solution unit is specifically configured to solve the continental shelf profile two-dimensional model in an x-z coordinate system to generate the relational expression.

In a third aspect, the present disclosure provides an electronic device, comprising a memory, a processor and a computer program stored in the memory and runnable in the processor, and when executing the computer program, the processor implements the steps of the method for determining the continental shelf profile based on non-delta transgression.

In a fourth aspect, the present disclosure provides a computer-readable storage medium in which a computer program is stored, wherein when executed by a processor, the computer program implements the steps of the method for determining the continental shelf profile based on non-delta transgression.

As can be seen from the above description, in the method and apparatus for determining the continental shelf profile based on non-delta transgression provided by the embodiments of the present disclosure, firstly, a continental shelf profile two-dimensional model is constructed based on a river supply sediment volume and a sea level rise rate in a target work area; next, the continental shelf profile two-dimensional model is solved in a spatial rectangular coordinate system to generate a relational expression which is capable of representing a non-delta transgression slope and a river length; and finally, a continental shelf profile of the target work area is determined based on the relational expression. In the context of non-delta transgression, the present disclosure comprehensively considers the influences of the river sediment supply and sea level rise on the continental shelf profile to more accurately determine the change of the continental shelf profile of the target work area in the historical period.

### BRIEF DESCRIPTION OF THE DRAWINGS

In order to more clearly describe the technical solutions in the embodiments of the present disclosure or in the prior art, the drawings to be used in the description of the embodiments or the prior art will be briefly introduced as follows. Obviously, the drawings in the following description are just some embodiments of the present disclosure, and those skilled of ordinary skill in the art may obtain other drawings from them without paying any creative effort.

FIG. 1 is a schematic diagram of a continental shelf equilibrium profile based on Bruun's rule in the background of the present disclosure;

FIG. 2 is a flowchart of a method for determining a continental shelf profile based on non-delta transgression according to an embodiment of the present disclosure;

FIG. 3 is a flowchart of Step 100 according to an embodiment of the present disclosure:

FIG. 4 is a schematic diagram of a longitudinal area increment of an alluvial range formed within a time increment Δt according to an embodiment of the present disclosure;

FIG. 5 is a flowchart of Step 200 according to an embodiment of the present disclosure;

FIG. 6 is a schematic diagram for solving a non-delta transgression profile according to a specific application example of the present disclosure;

FIG. 7 is a graph of a relationship between a continental shelf slope (ϕ) and a dimensionless river length (L*) according to a specific application example of the present disclosure:

FIG. 8 is a schematic diagram of setting an x-z coordinate system according to a specific application example of the present disclosure;

FIG. 9 is a flowchart of a method for determining a continental shelf profile based on non-delta transgression according to a specific application example of the present disclosure;

FIG. 10 is a structural diagram of an apparatus for determining a continental shelf profile based on non-delta transgression in the embodiment of the present disclosure;

FIG. 11 is a structural diagram of a model construction unit 10 in the apparatus for determining a continental shelf profile based on non-delta transgression according to an embodiment of the present disclosure; and

FIG. 12 is a block diagram of a system configuration of an electronic device 600 according to an embodiment of the present disclosure.

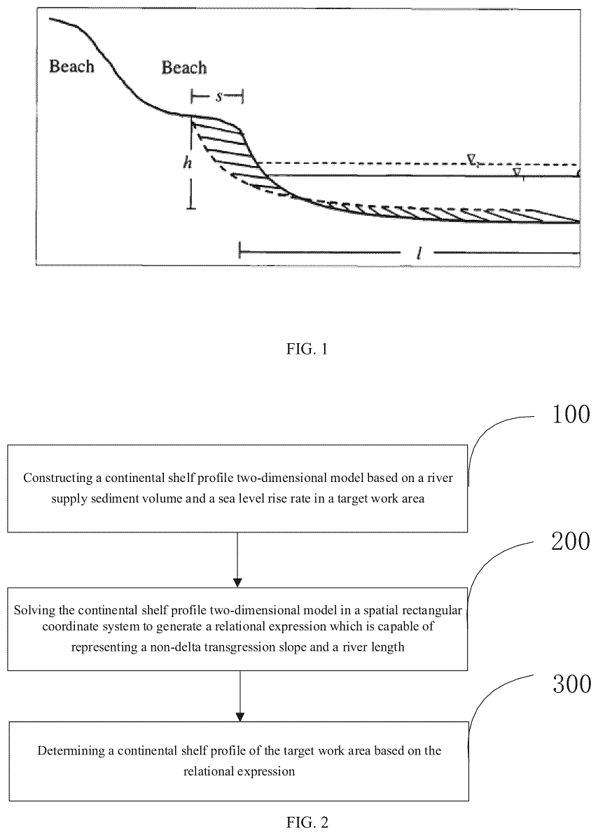

### DETAILED DESCRIPTION

In order that the objectives, the technical solutions and the advantages of the embodiments of the present disclosure are clearer, the technical solutions in the embodiments of the present disclosure will be described clearly and completely below with reference to the drawings for the embodiments of the present disclosure. Obviously, those described are parts, rather than all, of the embodiments of the present disclosure. Based on the embodiments in the present disclosure, any other embodiment obtained by those of ordinary skill in the art without paying any creative labor should fall within the protection scope of the present disclosure.

Those skilled in the art should appreciate that any embodiment of the present disclosure can be provided as a method, a system or a computer program product. Therefore, the present disclosure may take the form of a full hardware embodiment, a full software embodiment, or an embodiment combining software and hardware. Moreover, the present disclosure may take the form of a computer program product implemented on one or more computer usable storage mediums (including, but not limited to, a magnetic disc memory, CD-ROM, optical storage, etc.) containing therein computer usable program codes.

It should be noted that the terms ‘comprise’ and ‘have’ and any variations thereof in the specification and claims of the present disclosure and the above drawings are intended to cover a non-exclusive inclusion. For example, a process, method, system, product or device that includes a series of steps or units is not necessarily limited to those explicitly listed, but may include other steps or units not explicitly listed or inherent to such process, method, product or device.

It should be noted that the embodiments in the present disclosure and the features therein can be combined with each other when there is no conflict. The present disclosure will be described in detail below with reference to the drawings and in conjunction with the embodiments.

An embodiment of the present disclosure provides an implementation of a method for determining a continental shelf profile based on non-delta transgression. Referring to FIG. 2, the method specifically includes:

Step 100: constructing a continental shelf profile two-dimensional model based on a river supply sediment volume and a sea level rise rate in a target work area.

It can be understood that the target work area is in a sedimentary context of the non-delta transgression. In addition, it should be noted that only when the sea level retreats landwards, it is called transgression and a new continental shelf can be formed. The transgression may be further divided into two cases: a delta transgression and a non-delta transgression. The delta transgression means that a delta develops at the end of the river, and the non-delta transgression means that no delta develops at the end of the river, which depends on the river length. The non-delta transgression occurs when the length (L) of an alluvial river is greater than a critical length L_{crt}(L>L_{crt}), otherwise the delta transgression occurs when L<L_{crt}.

Step 200: solving the continental shelf profile two-dimensional model in a spatial rectangular coordinate system to generate a relational expression which is capable of representing a non-delta transgression slope and a river length.

Specifically, the continental shelf is placed in an x-z coordinate system (x represents a horizontal direction and a represents a vertical direction) and a slope of a continental shelf profile at a certain position is equivalent to a tangent slope of the continental shelf profile at the position. Therefore, in the x-z coordinate system, it is possible to find a solution for the non-delta transgression profile.

Step 300: determining a continental shelf profile of the target work area based on the relational expression.

Since the relational expression in Step 300 can represent the non-delta transgression slope, it can determine the continental shelf profile of the target work area.

As can be seen from the above description, in the method for determining the continental shelf profile based on non-delta transgression provided by the embodiments of the present disclosure, firstly, a continental shelf profile two-dimensional model is constructed based on a river supply sediment volume and a sea level rise rate in a target work area; next, the continental shelf profile two-dimensional model is solved in a spatial rectangular coordinate system to generate a relational expression which is capable of representing a non-delta transgression slope and a river length; and finally, a continental shelf profile of the target work area is determined based on the relational expression. In the context of non-delta transgression, the present disclosure comprehensively considers the influences of the river sediment supply and the sea level rise on the continental shelf profile to more accurately determine the change of the continental shelf profile of the target work area in the historical period.

In an embodiment, in the continental shelf profile two-dimensional model:

an inland basement slope, an alluvial slope, a sediment supply rate of an upstream of the river and the sea level rise rate are all constant; and

the river has an initial length at the beginning of a sea level rise.

It can be understood that in order to find a quantitative relationship between the non-delta transgression slope (i.e., a continental shelf slope ϕ) and river length (L), a two-dimensional geometric model is adopted to illustrate the change processes of the river length change (L>>L_{crt}) and the continental shelf slope as the sea level rises. For simplicity, the following conditions are adopted in the process of constructing the continental shelf profile two-dimensional model:
(1) The inland basement slope (γ) and the alluvial slope (α) remain constant.
(2) The sediment supply rate of the upstream (qₛ, a sediment volume supply rate per unit width in a two-dimensional space) remains constant (i.e. qₛ=constant value).
(3) From the beginning to the end of the sea level rise, the river length (L) is always greater than the critical value (L>>L_{crt}), that is, the transgression remains as the non-delta transgression.
(4) The sea level rise rate remains constant (Rₛₗ=constant value>0).
(5) The river has an initial length (L₀; L₀>>L_{crt}) at the beginning of a sea level rise.

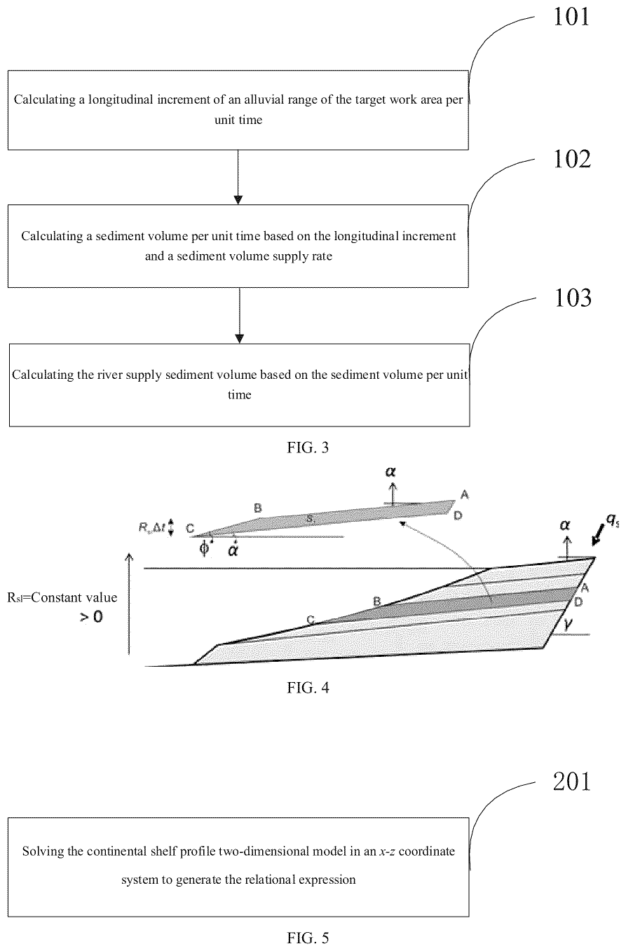

In an embodiment, referring to FIG. 3, Step 100 further includes:

Step 101: calculating a longitudinal increment of an alluvial range of the target work area per unit time;

referring to FIG. 4, the longitudinal increment of the alluvial range formed in a time increment Δₜ is calculated. Through approximate processing, the spatial increment may be regarded as a trapezoidal shape, and an expression of a trapezoidal area S₁ is be obtained:

$${S}_{1} = \frac{{LR}_{blr} Δ t}{\sqrt{1 + {α}^{2}}} ( 1 - \frac{α}{ϕ} ) - \frac{{( {R}_{blr} Δ t )}^{2} ( ϕ - α ) ( 1 + α ϕ )}{2 {ϕ}^{2} ( 1 + {α}^{2} )} + \frac{{( {R}_{blr} Δ t )}^{2} ( 1 + α ϕ )}{2 ( γ - α ) ( 1 + {α}^{2} )} {( 1 - \frac{α}{ϕ} )}^{2} , \qquad ( 1 )$$

Step 102: calculating a sediment volume per unit time based on the longitudinal increment and a sediment volume supply rate;

specifically, the sediment volume supplied during Δₜ is calculated, which is represented by S₂, that is:

$${S}_{2} = {q}_{s} Δ t , \qquad ( 2 )$$

Step 103: calculating the river supply sediment volume based on the sediment volume per unit time.

In an embodiment, referring to FIG. 5, Step 200 further includes:

Step 201: solving the continental shelf profile two-dimensional model in an x-z coordinate system to generate the relational expression.

It can be understood that a point O in a space is arbitrarily selected, and three number axes x, y and z perpendicular to each other are drawn through the point O, all of which take O as an origin and have a same length unit. These three axes are called a horizontal axis, a longitudinal axis, and a vertical axis, and the coordinate system is called a spatial rectangular coordinate system.

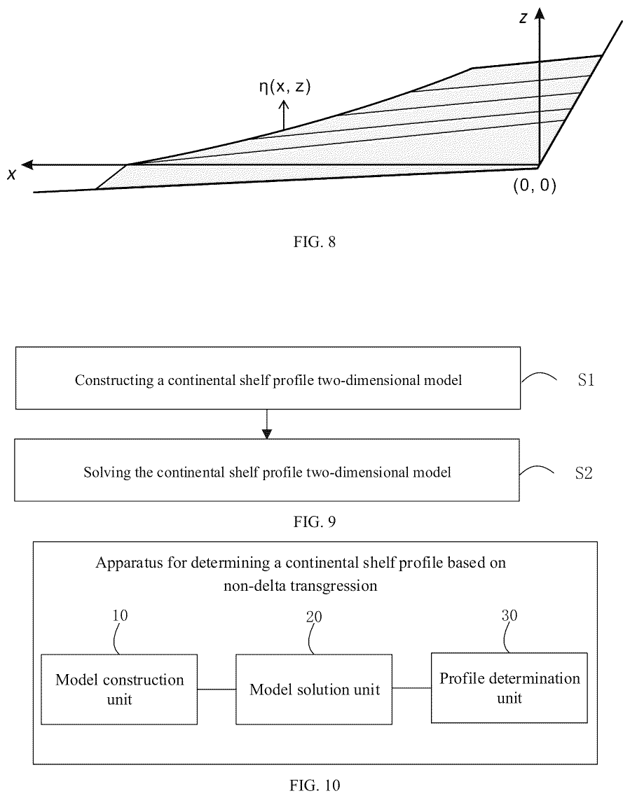

In order to further illustrate the solution, the present disclosure further provides a specific application example of a method for determining a continental shelf profile based on non-delta transgression, which specifically includes the following content, as illustrated in FIG. 9.

In order to overcome various problems in the prior art, in this specific application example, the sea level rise and the fluvial action are simultaneously considered, i.e., under the joint effect thereof, to determine the conditions for the formation of the continental shelf and the theoretical profile shape.

It can be understood that during the sea level rise, the coastline may either advance seawards or retreat landwards, or even remain at its original position, which depends on the relative strengths of the river sediment supply and the sea level rise. The sea level rise will generate an extra space for sediment filling. When enough sediments are transported by the river and partly remained after the space is filled up, the remained sediments will make an epeirogenetic movement and the coastline will advance seawards. On the contrary, when the sediments transported by the river are not enough to fill the space generated by sea level rise, the sea level will retreat landwards. If the sediments transported by the river just fills up the above space, the coastline remains at its original position. Only when the sea level retreats landwards, it is called transgression and a new continental shelf is formed. The transgression may be further divided into two cases: a delta transgression and a non-delta transgression. The delta transgression means that a delta develops at the end of the river, and the non-delta transgression means that no delta develops at the end of the river, which depends on the river length. Researches show that the non-delta transgression occurs when the length (L) of an alluvial river is greater than a critical length L_{crt}(L>L_{crt}), otherwise the delta transgression occurs when L<L_{crt} (Tomer et al., 2011: Wang et al., 2019). It is conceivable that for a large river-delta system (L>L_{crt}), the sea level rise is generally manifested as a non-delta transgression. With the continuation of the transgression and the shortening of the river length, the delta will be reformed when L>L_{crt} (Tomer et al., 2011).

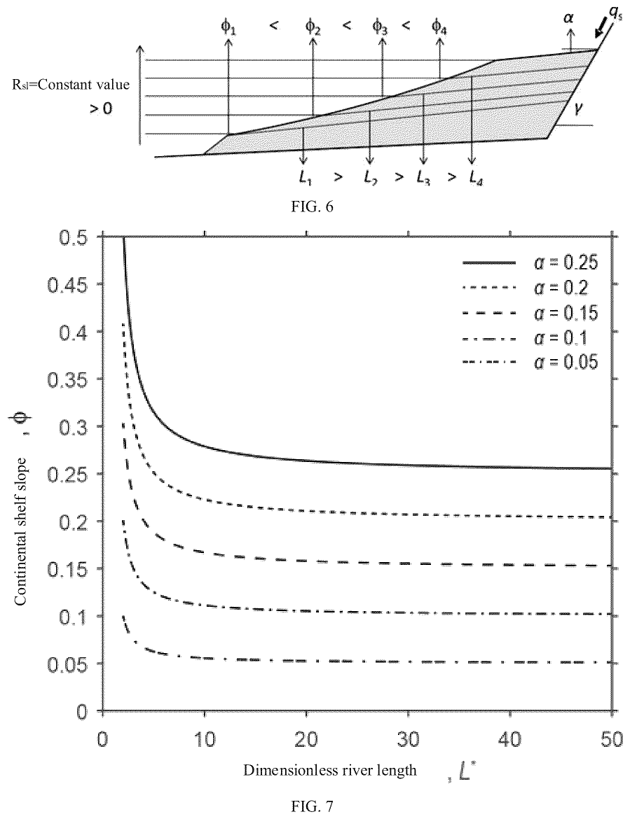

This specific application example only concerns the case of the non-delta transgression (FIG. 6). FIG. 6 is schematic diagram for solving a non-delta transgression profile. Rₛₗ represents a sea level change rate (>0 indicating a rise), and qₛ represents a sediment supply rate. L represents a river length, which become shorter with the sea level rises, and ϕ represents a continental shelf slope corresponding to L and becomes larger as L becomes shorter. α is a fluvial slope and γ represents an inland basement slope. ΔH represents a differential unit of the sea level rise.

In the non-delta transgression, all of the sediments are deposited above sea level. Assuming that the sediment supply rate is constant, the accretion rate of the sediments on the river surface is inversely proportional to the river length. If the river length is very long (L>>L_{crt}), the accretion rate along the alluvial profile will be very low, the accumulation of the sediments near the coastline will be limited, and the coastline will be able to migrate landwards more ‘freely’. In contrast, if the river length is short (yet L>L_{crt}), the accretion rate of the sediments near the coastline will increase, resulting in a steeper continental shelf, and the landward migration of the coastline will also be limited (slowed down). Therefore, after the river retrogrades landwards and the length (L) is shortened, the morphology of the non-delta transgression profile generally steepens in the upstream (as illustrated in FIG. 6).

S1: constructing a continental shelf profile two-dimensional model.

On the basis of formula (2), when the newly continental shelf formed by the sea level rise during Δt can be linearly approximated (i.e. the slope of the new continental shelf=constant value), there is a relationship of S₁≈S₂. At this time, it can be obtained:

$$\frac{{LR}_{blr} Δ t}{\sqrt{1 + {α}^{2}}} ( 1 - \frac{α}{ϕ} ) - \frac{{( {R}_{blr} Δ t )}^{2} ( ϕ - α ) ( 1 + α ϕ )}{2 {ϕ}^{2} ( 1 + {α}^{2} )} + \frac{{( {R}_{blr} Δ t )}^{2} ( 1 + α ϕ )}{2 ( γ - α ) ( 1 + {α}^{2} )} {( 1 - \frac{α}{ϕ} )}^{2} \approx {q}_{s} Δ t , \qquad ( 3 )$$

Both sides of formula (3) are simultaneously divided by R_{blr}qₛΔt to obtain:

$$\frac{L}{\sqrt{1 + {α}^{2}}} ( 1 - \frac{α}{ϕ} ) - \frac{( ϕ - α ) ( 1 + α ϕ ) {R}_{blr} Δ t}{2 {ϕ}^{2} ( 1 + {α}^{2} )} + \frac{( 1 + αϕ ) {R}_{blr} Δ t}{2 ( γ - α ) ( 1 + {α}^{2} )} ( 1 - \frac{α}{ϕ} ) \approx \frac{{q}_{s}}{{R}_{blr}} , \qquad ( 4 )$$

in which, when it is set:

$$\frac{{q}_{s}}{{R}_{blr}} = {Λ}_{2 D} , \qquad ( 5 )$$

Λ_{2D} represents a spatial scale measurement in the context of the sea level rise and fall in a two-dimensional space, with a unit of length.

Then:

$$\frac{L}{\sqrt{1 + {α}^{2}}} ( 1 - \frac{α}{ϕ} ) - \frac{( ϕ - α ) ( 1 + αϕ ) {R}_{blr} Δ t}{2 {ϕ}^{2} ( 1 + {α}^{2} )} + \frac{( 1 + αϕ ) {R}_{blr} Δ t}{2 ( γ - α ) ( 1 + {α}^{2} )} ( 1 - \frac{α}{ϕ} ) \approx {Λ}_{2 D} , \qquad ( 6 )$$

Next, the transgression profile slope is solved by a differential method. In fact, S₁≈S₂ is tenable only when Δt is infinitely close to 0. In this way, the above equation may be abbreviated as:

$$\frac{L}{\sqrt{1 + {α}^{2}}} ( 1 - \frac{α}{ϕ} ) = {Λ}_{2 D} , \qquad ( 7 )$$

$$or$$

$$ϕ = \frac{α L}{L - {Λ}_{2 D} \sqrt{1 + {α}^{2}}} , \qquad ( 8 )$$

The above equation is an analytical solutions of ϕ, which depends on L and Λ_{2D}, and is applicable to the non-delta transgression (i.e., L>L_{crt}).

The numerator and the denominator on the right side of the equation in Formula (8) are divided by Λ_{2D} simultaneously, that is, the river length L is made dimensionless, thereby obtaining formula (9). Formula (9) is a general form of the slope of any non-delta transgression profile and the river length (dimensionless).

$$ϕ = \frac{α {L}^{*}}{{L}^{*} - \sqrt{1 + {α}^{2}}} , \qquad ( 9 )$$

Where, the superscript * represents a dimensionless quantity.

Referring to FIG. 7, a graph of a correlation relationship between ϕ and L*, it can be seen from the graph that the ϕ and L* are inversely correlated. As can be seen from FIG. 7,
(1) If L (or L*) is very large, ϕ approaches α. The continental shelf profile is consistent with the river profile.
(2) With the shortening of L (or L*), the continental shelf slope (ϕ) steepens, and the continental shelf profile gradually moves away from the original river profile during transgression.

The above equation provides a mathematical solution for physical interpretation: since the river accretion rate is inversely proportional to the river length, the sea level rise in a long alluvial river will not effectively move the flooding surface away from the existing river profile. That is, as the sea level rises, the formed continental shelf is steepened landwards and gentled seawards, and infinitely close to the slope of the early-exposed river seawards.

S2: solving the continental shelf profile two-dimensional model.

Firstly, the expression form of transgression profile slope is transformed. Mathematically speaking, when the continental shelf is placed in an x-z coordinate system (x represents a horizontal direction and z represents a vertical direction), a slope of a continental shelf profile at a certain position is equivalent to a tangent slope (i.e., ϕ) of the continental shelf profile at the position. Therefore, in the x-z coordinate system, it is possible to find a solution for the non-delta transgression profile.

The origin of the x-z coordinate system is set to be an intersection of a horizontal line passing through an edge point of the continental shelf and an inland profile (FIG. 8), when t=0 (the sea level just begins to rise). Within the coordinate system specified, L has the following form:

$$L = \frac{\sqrt{1 + {α}^{2}} ( γ x + z )}{γ - α} , \qquad ( 10 )$$

By substituting Formula (10) into Formula (8), ϕ can be represented by the x-z coordinates and α, γ and Λ_{2D}:

$${ϕ}_{x , z} = \frac{α ( γ x + z )}{( γ x + z ) - {Λ}_{2 D} ( γ - α )} . \qquad ( 11 )$$

FIG. 7 is a schematic diagram of the setting of an x-z coordinate system (x represents a horizontal direction which is positive seawards, and z represents a vertical direction which is positive upwards) applicable to the present disclosure. Note: the coordinate origin is an intersection of a horizontal line passing through an edge point of the continental shelf and an inland profile, when t=0 (the sea level just begins to rise).

Next, the expression form of the transgression profile is determined. Since ϕ represents a tangent slope of the continental shelf profile at any position, Formula (11) represents a derived function of the transgression profile, i.e., the transgression profile should be an primitive function of the shown Formula (11). Assuming that η(x, z) is the primitive function, it may be expressed as an integral of Formula (11) from an initial position (x₀, z) to (x, z):

$${η}_{x , z} = {\int }_{( {x}_{0} , 0 )}^{( {x}_{1} , {z}_{1} )} \frac{α ( γ x + z )}{( γ x + z ) - {Λ}_{2 D} ( γ - α )} dxdz , \qquad ( 12 )$$

where (x₀, 0) and (x₁, z₁) represent an initial coastline position and a final coastline position, respectively. Specifically, at the initial coastline position, there is a relational expression:

$${x}_{0} = \frac{{L}_{0} ( γ - α )}{γ \sqrt{1 + {α}^{2}}} . \qquad ( 13 )$$

where L₀ represents a river length when t=0) (the sea level just begins to rise). The inequation L≥L_{crt} is still satisfied at the final coastline position (x₁, z₁). Equation (12) has no analytical solution, but a numerical solution may be obtained by means of numerical simulation.

The non-dimensionalization of the coordinate system and the expression of the transgression profile: in Formulas (11) to (13), it is also possible to divide the numerator and the denominator on the right side of the equation by Λ_{2D} to obtain the general expressions of the non-dimensionalized transgression profile.

$${ϕ}_{{x}^{*} , {z}^{*}} = \frac{α ( γ {x}^{*} + {z}^{*} )}{( γ {x}^{*} + {z}^{*} ) - ( γ - α )} . \qquad ( 14 )$$

$${η}_{{x}^{*} , {z}^{*}} = {\int }_{( {x}_{0}^{*} , 0 )}^{( {x}_{1}^{*} , {z}_{1}^{*} )} \frac{α ( γ {x}^{*} + {z}^{*} )}{( γ {x}^{*} + {z}^{*} ) - ( γ - α )} {dx}^{*} {dz}^{*} , \qquad ( 15 )$$

$${x}_{0}^{*} = \frac{{L}_{0}^{*} ( γ - α )}{γ \sqrt{1 + {α}^{2}}} , \qquad ( 16 )$$

where, the superscript * represents a dimensionless quantity.

As can be seen from the above description, the method for determining the continental shelf profile based on non-delta transgression provided by the embodiments of the present disclosure firstly selects independent variables based on internal detection data of a pipeline, then selects the input variables using a Lasso algorithm, and finally adopts a generalized linear additive model driven by the internal detection data for predicting corrosion defects in the pipeline. The embodiments of the present disclosure may construct a model based on the existing two internal corrosion data to estimate a corrosion depth in future. Since the analysis result of the model may provide a reference for the dangerous defects of the pipeline, it may be an important part of the integrity management and help to determine an internal inspection period and make a maintenance plan, which is conducive to the safe operation of the pipeline. Specifically, the embodiments of the present disclosure have the following advantageous effects:

Based on the same invention concept, an embodiment of the present disclosure further provides an apparatus for determining a continental shelf profile based on non-delta transgression, which can implement the method described in the above embodiments, as described in the following embodiment. Since the principle for the apparatus for determining the continental shelf profile based on non-delta transgression to solve the problem is similar to that for the method for determining the continental shelf profile based on non-delta transgression, the implementation of the apparatus for determining the continental shelf profile based on non-delta transgression may refer to that of the method for determining the continental shelf profile based on non-delta transgression, and the repeated content is omitted. As used below, the term ‘unit’ or ‘module’ may realize a combination of software and/or hardware of predetermined functions. Although the system described in the following embodiments is preferably implemented in software, the implementation of hardware, or a combination of software and hardware, is also possible and contemplatable.

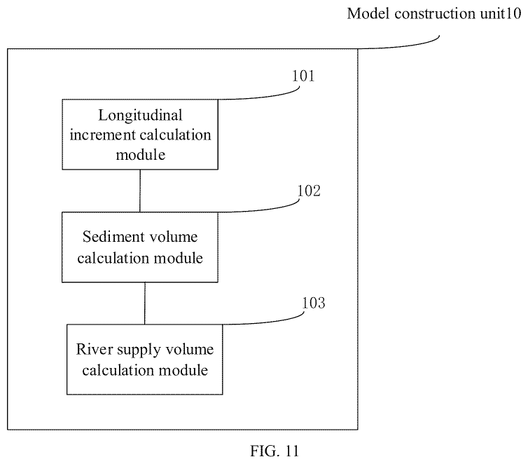

An embodiment of the present disclosure provides an implementation of an apparatus for determining a continental shelf profile based on non-delta transgression capable of implementing the method for determining the continental shelf profile based on non-delta transgression. As illustrated in FIG. 10, the apparatus for determining the continental shelf profile based on non-delta transgression specifically includes:

a model construction unit 10 configured to construct a continental shelf profile two-dimensional model based on a river supply sediment volume and a sea level rise rate in a target work area;

a model solution unit 20 configured to solve the continental shelf profile two-dimensional model in a spatial rectangular coordinate system to generate a relational expression which is capable of representing a non-delta transgression slope and a river length; and

a profile determination unit 30 configured to determine a continental shelf profile of the target work area based on the relational expression

In an embodiment, referring to FIG. 11, the model construction unit 10 includes:

a longitudinal increment calculation module 101 configured to calculate a longitudinal increment of an alluvial range of the target work area per unit time;

a sediment volume calculation module 102 configured to calculate a sediment volume per unit time based on the longitudinal increment and a sediment volume supply rate; and

a river supply volume calculation module 103 configured to calculate the river supply sediment volume based on the sediment volume per unit time.

In an embodiment, in the continental shelf profile two-dimensional model:

an inland basement slope, an alluvial slope, a sediment supply rate of an upstream of the river and the sea level rise rate are all constant; and

the river has an initial length at the beginning of a sea level rise.

In an embodiment, the model solution unit 20 is specifically configured to solve the continental shelf profile two-dimensional model in an x-z coordinate system to generate the relational expression.

As can be seen from the above description, in the apparatus for determining the continental shelf profile based on non-delta transgression provided by the embodiments of the present disclosure, firstly, a continental shelf profile two-dimensional model is constructed based on a river supply sediment volume and a sea level rise rate in a target work area; next, the continental shelf profile two-dimensional model is solved in a spatial rectangular coordinate system to generate a relational expression which is capable of representing a non-delta transgression slope and a river length; and finally, a continental shelf profile of the target work area is determined based on the relational expression. In the context of non-delta transgression, the present disclosure comprehensively considers the influences of the river sediment supply and the sea level rise on the continental shelf profile to more accurately determine the change of the continental shelf profile of the target work area in the historical period.

An embodiment of the present disclosure further provides an electronic device, which may be a desktop computer, a tablet computer, a mobile terminal, etc., and the embodiment is not limited thereto. In this embodiment, the electronic device may refer to the implementations of the method and the apparatus in the above embodiments, the contents of which are incorporated here, and the repeated content is omitted.

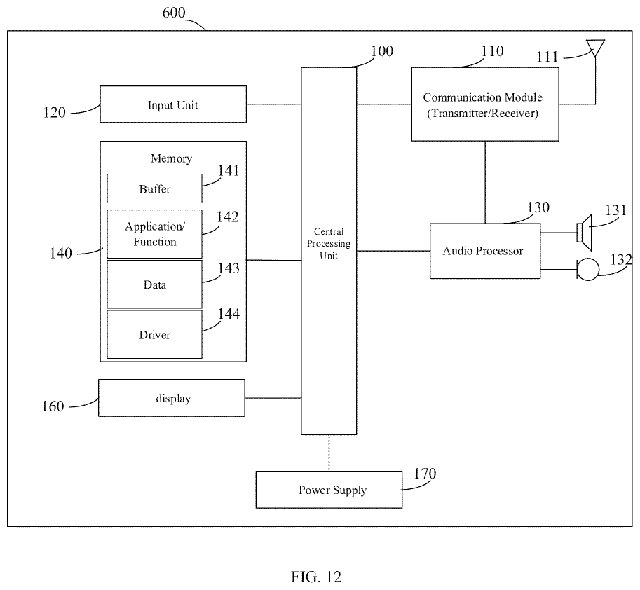

FIG. 12 is a block diagram of a system configuration of an electronic device 600 according to an embodiment of the present disclosure. As illustrated in FIG. 12, the electronic device 600 may include a central processing unit 100 and a memory 140; the memory 140 is coupled to the central processing unit 100. It should be noted that the figure is exemplary, and any other type of structure may be adopted to supplement or replace this structure to realize a telecommunication or other functions.

In an embodiment, the method for determining the continental shelf profile based on non-delta transgression may be integrated into the central processing unit 100. In which, the central processing unit 100 may be configured to perform the controls of:

constructing a continental shelf profile two-dimensional model based on a river supply sediment volume and a sea level rise rate in a target work area;

solving the continental shelf profile two-dimensional model in a spatial rectangular coordinate system to generate a relational expression which is capable of representing a non-delta transgression slope and a river length; and

determining a continental shelf profile of the target work area based on the relational expression.

In another embodiment, the apparatus for determining a continental shelf profile based on non-delta transgression may be configured separately from the central processing unit 100. For example, the apparatus for determining a continental shelf profile based on non-delta transgression may be configured as a chip connected to the central processing unit 100, so as to realize the management and control function of the method for determining the continental shelf profile based on non-delta transgression by the control of the central processing unit.

As illustrated in FIG. 12, the electronic device 600 may further include a communication module 110, an input unit 120, an audio processing unit 130, a display 160, and a power supply 170. It should be noted that the electronic device 600 does not necessarily include all the components illustrated in FIG. 12. In addition, the electronic device 600 may further include components not illustrated in FIG. 12, and reference may be made to the prior art.

As illustrated in FIG. 12, the central processing unit 100, sometimes called a controller or an operation control, may include a microprocessor or any other processor device and/or logic device, and receive an input and control operations of respective components of the electronic device 600.

In which, the memory 140 may be, for example, one or more of a buffer, a flash memory, a hard drive, a removable medium, a volatile memory, a nonvolatile memory or any other suitable device. The memory 140 may store information related to a failure, and a program for executing related information. In addition, the central processing unit 100 may execute the program stored in the memory 140 to realize information storage, processing, etc.

The input unit 120 provides an input to the central processing unit 100. The input unit 120 is, for example, a key or a touch input device. The power supply 170 is configured to supply power to the electronic device 600. The display 160 is configured to display an object to be displayed, such as an image or a text. The display may be, for example, an LCD display, but is not limited thereto.

The memory 140 may be a solid-state memory, such as a read only memory (ROM), a random-access memory (RAM), a SIM card, etc. The memory 140 may also be a memory that holds information even when power is off, and can be selectively erased and provided with more data, and an example of the memory 140 is sometimes called an EPROM, etc. The memory 140 may also be some other type of device. The memory 140 includes a buffer memory 141 (also called a buffer). The memory 140 may include an application/function storage section 142 configured to store application programs and function programs or execute an operation flow of the electronic device 600 by the central processing unit 100.

The memory 140 may further include a data storage section 143 which stores data, such as contacts, numerical data, pictures, sounds and/or any other data used by the electronic device. A driver storage section 144 of the memory 140 may include various drivers for the communication function and/or other functions (e.g., messaging application, address book application, etc.) of the electronic device.

The communication module 110 is a transmitter/receiver which transmits and receives signals via an antenna 111. The communication module (transmitter/receiver) 110 is coupled to the central processing unit 100 to provide an input signal and receive an output signal, which may be the same as the case of a conventional mobile communication terminal.

Based on different communication technologies, a plurality of communication modules 110, such as a cellular network module, a Bluetooth module and/or a wireless local area network module, may be provided in a same electronic device. The communication module (transmitter/ receiver) 110 is further coupled to a speaker 131 and a microphone 132 via an audio processor 130 to provide an audio output via the speaker 131 and receive an audio input from the microphone 132, thereby realizing the general telecommunications function. The audio processor 130 may include any suitable buffer, decoder, amplifier, etc. In addition, the audio processor 130 is further coupled to the central processing unit 100, so that audios can be recorded locally through the microphone 132 and sound stored locally can be played through the speaker 131.

An embodiment of the present disclosure may further provide a computer-readable storage medium capable of implementing all the steps of the method for determining the continental shelf profile based on non-delta transgression in the above embodiments. The computer-readable storage medium stores a computer program, which when executed by a processor implements all the steps of the method for determining the continental shelf profile based on non-delta transgression in the above embodiments. For example, the following steps are implemented when the processor executes the computer program:

constructing a continental shelf profile two-dimensional model based on a river supply sediment volume and a sea level rise rate in a target work area;

solving the continental shelf profile two-dimensional model in a spatial rectangular coordinate system to generate a relational expression which is capable of representing a non-delta transgression slope and a river length; and

determining a continental shelf profile of the target work area based on the relational expression.

The embodiments of the present disclosure are all described in a progressive manner, and the same or similar portions of the embodiments can refer to each other Each embodiment lays an emphasis on its distinctions from other embodiments. In particular, an embodiment of hardware plus program is simply described since it is substantially similar to the embodiments of the method, and please refer to the descriptions of the embodiments of the method for the relevant parts.

The specific embodiments of the present disclosure have been described above, and other embodiments are within the scope of the appended claims. In some cases, the actions or steps recited in the claims may be performed in a different order than in the embodiments and still achieve the desired results. In addition, the processes depicted in the drawings do not necessarily require a specific order illustrated or a consecutive order to achieve the desired results. In some embodiments, multitasking and parallel processing are also possible or may be advantageous.

Although the present disclosure provides the methodical operation steps as described in the embodiments or the flowcharts, more or fewer operation steps may be included based on the conventional or non-inventive labor. The step execution order listed in the embodiments is only one of many step execution orders and does not represent a unique execution order. In case of an actual device or terminal product, the steps may be executed orderly or in parallel (e.g., by the parallel processors, or under a multi-thread processing environment) according to the method illustrated in the embodiments or the drawings.

Although the embodiments of the present disclosure provide methodical operation steps as described in the embodiments or the flowcharts, more or fewer operation steps may be included based on the conventional or non-inventive means. The step execution order listed in the embodiments is only one of many step execution orders and does not represent a unique execution order. In case of an actual device or terminal product, the steps may be executed orderly or in parallel (e.g., by the parallel processors, or under a multi-thread processing environment or even a distributed data processing environment) according to the method illustrated in the embodiments or the drawings. The term ‘comprise’, ‘include’ or any other variant is intended to cover the non-exclusive inclusions. so that a process, a method, a product or a device including a series of elements include not only those elements, but also other elements not explicitly listed, or further include inherent elements of such process, method, product or device. In a case where there is no further limitation, it is not excluded that there are other identical or equivalent elements in the process, method, product or device including the elements.

In order to facilitate the description, the device is described based on the functions through various functional modules, respectively. Of course, during implementation of the embodiments of the present disclosure, the functions of the modules may be realized in the same or a plurality of software and/or hardware, or a module that realizes a function may be implemented by a combination of a plurality of submodules or subunits, and the like. The device embodiments described above are merely illustrative, e.g., the unit partitioning is only a logical function partitioning, and other partitioning modes are possible during the actual implementation. For example, a plurality of units or components may be combined or integrated into another system, or some features may be omitted or not executed. In addition, the mutual coupling or direct coupling or communication connection illustrated or discussed may be an indirect coupling or communication connection through some interfaces, devices or units, and may be in electrical, mechanical or other forms.

As known to those skilled in the art, in addition to implementing the controller by merely using computer readable program codes, the controller is completely enabled to realize the same function in the form of a logic gate, a switch, an ASIC, a programmable logic controller, an embedded microcontroller, etc., by logically programming the methodical steps. Thus, such a controller may be deemed as a hardware component, while devices included therein for realizing various functions may also be deemed as structures in the hardware component. Alternatively, those devices for realizing various functions may even be deemed as not only software modules for implementing a method, but also the structures in the hardware component.

The present disclosure is described with reference to a flowchart and/or a block diagram of the method, apparatus (system) and computer program product according to the embodiments of the present disclosure. It shall be appreciated that each flow and/or block in the flowchart and/or the block diagram and a combination of flows and/or blocks in the flowchart and/or the block diagram can be realized by computer program instructions. Those computer program instructions can be provided to a general computer, a dedicated computer, an embedded processor or a processor of other programmable data processing device to produce a machine, so that the instructions executed by the processor of the computer or other programmable data processing device produce devices for realizing specified functions in one or more flows in the flowchart and/or one or more blocks in the block diagram.

These computer program instructions may also be stored in a computer readable memory capable of guiding the computer or other programmable data processing devices to work in a particular manner, so that the instructions stored in the computer readable memory can produce manufacture articles including an instructing device which realizes function(s) specified in one or more flows in the flowchart and/or one or more blocks in the block diagram.

These computer program instructions may also be loaded onto the computer or other programmable data processing devices, so that a series of operation steps are performed on the computer or other programmable data processing devices to produce a processing realized by the computer, thus the instructions executed on the computer or other programmable devices provide step(s) for realizing function(s) specified in one or more flows in the flowchart and/or one or more blocks in the block diagram.

In a typical configuration, the computing device includes one or more processors (CPUs), an input/output interface, a network interface and a memory.

The memory may have the form of a non-permanent memory, a Random-Access Memory (RAM) and/or a nonvolatile memory such as Read-Only Memory (ROM) or a flash RAM, etc. among the computer readable medium. The memory is an example of the computer readable medium.

The computer-readable medium includes permanent and non-permanent, removable and non-removable media, which can realize the information storage in any method or technique. The information may be computer readable instructions, data structures, program modules or other data. An example of the computer storage medium includes, but not limited to, a phase change memory (PRAM), a static random access memory (SRAM), a dynamic random access memory (DRAM), other types of random access memory (RAM), a read-only memory (ROM), an electrically-erasable programmable read-only memory (EEPROM), a flash memory or other memory techniques, a compact disk read only memory (CD-ROM), a digital versatile disc (DVD) or other optical storages, magnetic cassette tapes, magnetic diskettes or other magnetic storage device or any other non-transmission medium, which can be used for the storage of information accessible to a computing device. According to the definitions herein, the computer readable medium does not include any temporary computer readable media (transitory media), such as modulated data signal and carrier wave.

Those skilled in the art should appreciate that any embodiment of the present disclosure can be provided as a method, a system or a computer program product. Therefore, the present disclosure can take the form of a full hardware embodiment, a full software embodiment, or an embodiment combining software and hardware. Moreover, the present invention can take the form of a computer program product implemented on one or more computer usable storage mediums (including, but not limited to, a magnetic disc memory, CD-ROM, optical storage, etc.) containing therein computer usable program codes.

The embodiments of the present disclosure may be described in the general context of computer executable instructions executed by the computer, e.g., the program module. In general, the program module includes routine, program, object, component, data structure, etc. executing a particular task or realizing a particular abstract data type. The embodiments of the present disclosure may also be put into practice in the distributed computing environments where tasks are executed by remote processing devices connected through a communication network. In the distributed computing environments, the program modules may be located in the local and remote computer storage medium including the storage device.

The embodiments of the present disclosure are all described in a progressive manner, and the same or similar portions of the embodiments can refer to each other. Each embodiment lays an emphasis on its distinctions from other embodiments. In particular, the system embodiment is simply described since it is substantially similar to the embodiments of the method, and please refer to the descriptions of the embodiments of the method for the relevant parts. In the description of the present disclosure, the description of reference terms ‘one embodiment’, ‘some embodiments’, ‘an example’, ‘a specific example’ or ‘some examples’ and the like mean that the specific features, structures, materials, or characteristics described in conjunction with the embodiment(s) or example(s) are included in at least one embodiment or example of the present disclosure. In the present disclosure, the schematic expressions of the above terms do not necessarily aim at the same embodiment or example. Moreover, the specific features, structures, materials, or characteristics described may be combined in any one or more embodiments or examples in a suitable manner. In addition, those skilled in the art may combine different embodiments or examples described in the present disclosure and features thereof if there is no contradiction.

Those described above are just examples of the embodiments of the present disclosure, rather than limitations thereto. For those skilled in the art, the embodiments of the present disclosure) may have various amendments or variations. Any amendment, equivalent substitution, improvement, etc. within the spirit and principle of the present disclosure should fall within the scope of the claims.

1. A method for determining a continental shelf profile based on non-delta transgression, comprising:
constructing a continental shelf profile two-dimensional model based on a river supply sediment volume and a sea level rise rate in a target work area;
solving the continental shelf profile two-dimensional model in a spatial rectangular coordinate system to generate a relational expression which is capable of representing a non-delta transgression slope and a river length; and
determining a continental shelf profile of the target work area based on the relational expression.

2. The method for determining the continental shelf profile based on non-delta transgression according to claim 1, wherein constructing a continental shelf profile two-dimensional model based on a river supply sediment volume and a sea level rise rate in a target work area comprises:
calculating a longitudinal increment of an alluvial range of the target work area per unit time;
calculating a sediment volume per unit time based on the longitudinal increment and a sediment volume supply rate; and
calculating the river supply sediment volume based on the sediment volume per unit time.

3. The method for determining the continental shelf profile based on non-delta transgression according to claim 2, wherein in the continental shelf profile two-dimensional model, an inland basement slope, an alluvial slope, a sediment supply rate of an upstream of the river and the sea level rise rate are all constant; and
the river has an initial length at the beginning of a sea level rise.

4. The method for determining the continental shelf profile based on non-delta transgression according to claim 1, wherein solving the continental shelf profile two-dimensional model in a spatial rectangular coordinate system to generate a relational expression which is capable of representing a non-delta transgression slope and a river length comprises:
solving the continental shelf profile two-dimensional model in an x-z coordinate system to generate the relational expression.

5. An apparatus for determining a continental shelf profile based on non-delta transgression, comprising:
a model construction unit configured to construct a continental shelf profile two-dimensional model based on a river supply sediment volume and a sea level rise rate in a target work area;
a model solution unit configured to solve the continental shelf profile two-dimensional model in a spatial rectangular coordinate system to generate a relational expression which is capable of representing a non-delta transgression slope and a river length; and
a profile determination unit configured to determine a continental shelf profile of the target work area based on the relational expression.

6. The apparatus for determining the continental shelf profile based on non-delta transgression according to claim 5, wherein the model construction unit comprises:
a longitudinal increment calculation module configured to calculate a longitudinal increment of an alluvial range of the target work area per unit time;
a sediment volume calculation module configured to calculate a sediment volume per unit time based on the longitudinal increment and a sediment volume supply rate; and
a river supply volume calculation module configured to calculate the river supply sediment volume based on the sediment volume per unit time.

7. The apparatus for determining the continental shelf profile based on non-delta transgression according to claim 6, wherein in the continental shelf profile two-dimensional model,
an inland basement slope, an alluvial slope, a sediment supply rate of an upstream of the river and the sea level rise rate are all constant; and
the river has an initial length at the beginning of a sea level rise.

8. The apparatus for determining the continental shelf profile based on non-delta transgression according to claim 5, wherein the model solution unit is specifically configured to solve the continental shelf profile two-dimensional model in an x-z coordinate system to generate the relational expression.

9. An electronic device, comprising a memory, a processor and a computer program stored in the memory and runnable in the processor, wherein when executing the computer program, the processor implements the steps of the method for determining the continental shelf profile based on non-delta transgression according to claim 1.

10. (canceled)
